(19) United States
(12) Patent Application Publication
(10) Pub. No.: US 2005/0060058 A1
(43) Pub. Date: Mar. 17, 2005

(54) Embroidery network control system and method

(76) Inventors: Marion Cameron, Scarborough (CA); Ioan Carabenciov, Jacksonville, FL (US); William Collins, Oakville (CA); William J. Davis, Kitchener (CA); Brian Goldberg, Thornhill (CA); Mohan Rao, Mississauga (CA); Anastasios Tsonis, Kitchener (CA); Craig West, Etobicoke (CA)

Correspondence Address: Charles T.J. Weigell, Esq.;Bryan Cave LLP, 1290 Avenue of the Americas, New York, NY, 10104, US

(21) Appl. No.: 10/850,629

(22) Filed: May 20, 2004

Related U.S. Application Data
(60) Provisional application No. 60/472,493, filed on May 22, 2003.

(51) Int. Cl. G06F 19/00; D05C 5/02

(52) U.S. Cl. 700/138

(57) ABSTRACT

A method and system of remotely communicating embroidery pattern data to embroidery machines involving providing an embroidery pattern in response to a pattern selection input from a remote user at a local node, the input communicated through a communications connection between the local node and a server, receiving an identification address for an embroidery machine, communicating the embroidery pattern to the embroidery machine for application of the embroidery pattern to a work piece. The system includes a server having circuitry for receiving wireless electronic communications, a local node having a graphical user interface for receiving input from a remote user, the local node in wireless electronic communication with the server, a database of electronically encoded data, the data comprising embroidery patterns, the database in communication with the server, and responsive to the local node input, to retrieve embroidery patterns and to display the embroidery patterns through the server to the remote user, and an embroidery machine in communication with the server, the embroidery machine receiving embroidery patterns from the database through the server.

### CLAIM TO PRIORITY

This application claims the benefit of U.S. Provisional Application No. 60/472,493 filed on May 21, 2003, the application and its disclosure being incorporated herein by reference in their entirety for all purposes.

### FIELD OF THE INVENTION

The present invention relates to embroidery systems and methods and particularly to implementing, controlling and monitoring the operation of embroidery systems from a remote source.

### BACKGROUND OF THE INVENTION

Embroidery systems having an embroidery machine for automatically embroidering stitch patterns on a garment are well known in the art, including such systems employing microprocessor control to create customized embroidery patterns, such as disclosed in U.S. Pat. Nos. 6,012,402; 5,988,083; 5,865,134; 5,924,374; and 5,924,372. In addition, such prior art systems have employed an embedded ROM for the control software, such as disclosed in U.S. Pat. No. 5,586,134, as well as using removable ROM cards to store embroidery pattern data, such as disclosed in U.S. Pat. No. 5,988,083. However, none of these prior art systems known to applicants have employed a wireless transmission system accessible through common mobile units to communicate with and send embroidery pattern data to multiple embroidery machines from sources remote from the system controller. The advantages of such a system are that it requires little or no customization or to load a specialized software platform to implement and initiate remote operation, and it also allows for the remote user to monitor the operations of multiple embroidery machines in the embroidery system.

Existing embroidery machines are built with a machine controller that includes a user interface for the machine operator to control the machine. Typical functions handled by the user-interface include loading a design to be stitched, assigning appropriate thread colors for various parts of the design, executing machine commands such as trims, speed changes, start and stops etc. The user interfaces are traditionally not graphical in nature. These machines typically do not have automatic functionality to collect production data (number of stitches sewn, up-time and down-time of the machine, cause of down time (thread breakages, etc.). Additionally, these machines have traditionally not been created with built-in network functionality. In such machines embroidery designs are loaded via a floppy disk interface. This is not a viable medium for a large manufacturing facility to manage its production.

In the past, embroidery machines were integrated into “push” or “pull” networks. In a “push” network a single computer is connected to a number of embroidery machines, through, for instance, a switch box, hub or routers, wherein designs are forwarded from the computer to each embroidery machine. There are two disadvantages to a push network. The embroidery machines are typically connected to the central computer via cables. The physical characteristics of the cable impose constraints that require the central computer and the embroidery devices to be in close relative proximity. A more significant disadvantage is that if many embroidery machines are connected to the central computer, as is the case in large manufacturing operations, a bottleneck is created at the central computer where individual machine operators are waiting to “push” their designs to the embroidery machine they are controlling. On the other hand the cost of a push network is relatively low because no special hardware is required. Only the central computer requires customized software that allows designs to be sent to the machine as well as any additional functionality on machine status that may be required.

An alternative to the push networks is a “pull” network. In this type of network, an intelligent device, such as a microprocessor based console or graphic interface, is connected to each embroidery machine. The intelligent device is connected to a central controller from which it retrieves embroidery designs, which it then forwards to the embroidery machine. Since the devices are connected to the embroidery machines and to the controller via cables, the same proximity requirements apply to this type of network as well. However, there is no bottleneck since individual operators use the devices at each embroidery machine to “pull” designs when needed. The primary disadvantage of this type of network is the high cost of the intelligent devices. Typically it involves custom hardware and software that support the communication and status/reporting functionality that is required.

### SUMMARY OF THE INVENTION

The present invention presents a new and unique improvement to an embroidery machine. The invention has two parts. The first part of the invention relates to a machine interface layer providing a connection between a server and a plurality of embroidery machines for sending designs and retrieving status information, linking the machines in parallel operation. The second part of the invention relates to a human interface layer where a common mobile unit is connected to a server via a wireless Local Area Network, or over the internet, without having to customize the unit or load specialized software thereon. The mobile unit graphic user interface allows a remote user to send a design selection to the server, designate the particular embroidery machines to perform the embroidery process and read the status of the operation of the embroidery machinery in real time.

The advantage offered by the machine interface level is a more efficient operation of embroidery machines in an industrial setting. This requires no retrofitting of existing machines with new technology in accordance with the present invention since the server provides the translation and communication means from a central location, akin to a “push” system. The advantage offered by the human interface level is that of increased access from remote locations to the designs and the operation status of the embroidery machines without requiring specialized hardware or software, thus streamlining a “pull” system. A centralized console may be employed to oversee the distributed communications and manufacturing system resulting from integration of the machine interface and human interface levels. Thus the capability of operating a plurality of machines in parallel from both a centralized and from remote locations adopts the most beneficial aspects of both “push” and “pull” systems.

A method is disclosed of remotely operating embroidery machines comprising the steps of providing an embroidery pattern in response to a pattern selection input from a remote user at a local node, the input communicated through a communications connection between the local node and a server, receiving an identification address for an embroidery machine selected from a plurality of embroidery machines, and communicating the embroidery pattern to the embroidery machine for application of the embroidery pattern to a work piece.

A computerized system is also disclosed, the system enabling users to remotely implement and monitor the application of embroidery patterns onto fabrics by embroidery machines, the system comprising a server having circuitry for receiving wireless electronic communications, a local node having a graphical user interface for receiving input from a remote user, the local node in wireless electronic communication with the server, a database of electronically encoded data, the data comprising embroidery patterns, the database in communication with the server, and responsive to the local node input, to retrieve embroidery patterns and to display the embroidery patterns through the server to the remote user, and an embroidery machine in communication with the server, the embroidery machine receiving embroidery patterns from the database through the server.

### BRIEF DESCRIPTION OF DRAWINGS

FIG. 1 is a graphical illustration of the presently preferred system architecture for an embroidery system network in accordance with the present invention;

FIG. 2 is a graphical illustration of the human interface level of the presently preferred system for carrying out the presently preferred method of the present invention utilizing the system architecture of FIG. 1;

FIG. 3 is a graphical illustration, of the machine interface level of the presently preferred system for carrying out the presently preferred method of the present invention utilizing the system architecture of FIG. 1;

FIG. 4 is a system flow diagram illustrating the steps for carrying out a method according to the present invention utilizing the system architecture of FIG. 1

FIG. 5 is a system flow diagram illustrating the steps for carrying out a method according to the present invention utilizing the system architecture of FIGS. 2 and 3.

### DETAILED DESCRIPTION OF THE PREFERRED EMBODIMENT

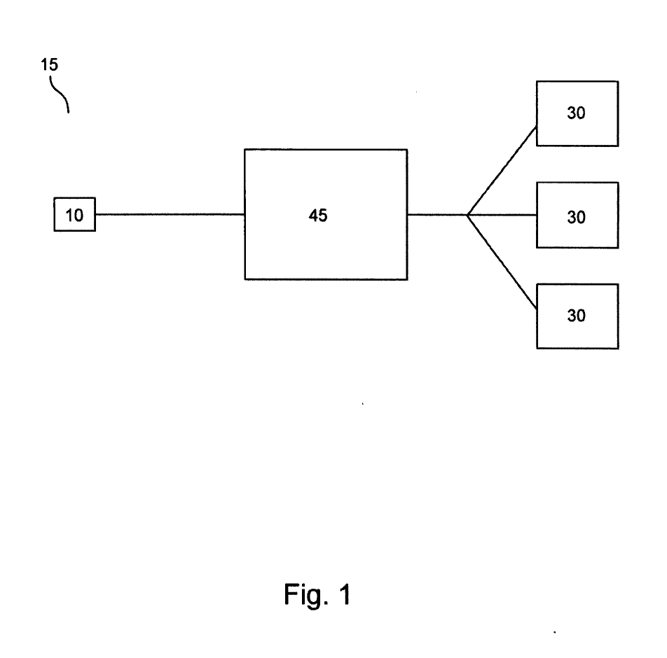

The invention is described with reference to the drawings. FIG. 1 illustrates the presently preferred embroidery network system architecture. The blocks in FIG. 1 illustrate components of an embroidery network system 15. The spatial layout and depiction of the system 15 in the drawings are done only for purposes of clarity and is simply one manner in which the various components of the network can be organized. It is to be therefore understood that the components and the functionalities described are not limited to any particular grouping, collection, or spatial relationship. Moreover, the components illustrated as part of the network may be in addition to other components, or to other functions and processes within the system 15, that are not described, or may be exclusive of other components.

The invention allows a remote user to remotely send embroidery pattern designs to particular embroidery machinery for application of the embroidyer pattern to workpieces (e.g., fabrics to be embroidered). The invention also encompasses enabling the remote user to monitor the application process performed by embroidery machines once in operation. Applicants use “remote” or “remotely” in the specification to express not only a physical separation between a user and an object, work unit, or device the user wishes to communicate with, monitor and/or control, and also may encompass a user's ability to move about and change the distance or direction of this physical separation and yet remain, as the case may be, in communication with or in operative contact or control with the object, work unit, or device. These “remote” capabilities encompass use of a wired or cabled connections and/or a network, as well as a wireless communications medium, by the remote user in the form of one or more mobile units that the user may transport, for instance, one the user may carry about within a given area, for instance, a manufacturing plant, while maintaining the communications link with the object, work unit or device.

As illustrated in FIG. 1, an embroidery network system 15 includes, a server 45, a local node 10 in communication with the server 45, and embroidery machines 30 in communication with the server 45. In accordance with the preferred embodiment, the method of the invention involves providing an embroidery pattern in response to a pattern selection input from a remote user at a local node 10. Preferably, the input is communicated through a wireless communications connection between the local node 10 and the server 45. Alternatively, a wired or cabled communication, using a wired LAN or other communication link or network may also be used. The embroidery pattern is preferably provided in the form of a digitally encoded computer readable data stored within system 15, for instance in an accessible database or program storage medium, and accessible to one or more of components 45, 10 and 30 illustrated in FIG.1. Various methods and systems for digitally encoding embroidery patterns, including customization of patterns by a user, and storing them in a system are known in the art. For purposes of illustration, such systems and methods include those discussed in the foregoing Description of Prior Art and those identified in U.S. Pat. No. 5,430,658: (Method for Creating Self-Generating Embroidery Pattern) and U.S. Pat. Nos. 5,668,730 and 5,510,994 (Method for Automatically Generating Chain Stitches), the disclosures of each of these pending applications are incorporated by reference in this specification. Preferably, the embroidery patterns are provided to system 15 through interaction between the server 45 and a database where the patterns may be stored wherein the server 45 retrieves the appropriate patterns from the database in response to the pattern selection input from the remote user. Other manners of providing an embroidery pattern, or data comprising or encoding an embroidery pattern, however, are within the scope and contemplation of the invention.

In conjunction with providing an embroidery pattern, the system 15 receives an identification address for an embroidery machine designated to apply the embroidery pattern to a work piece. Preferably, the identification address is an electronically encoded address that enables the communication of electronic data instructions to the embroidery machine to control its operation. The identification address may be hardcoded into the embroidery machine or a computer and/or router associated therewith, for instance, at a network interface of the embroidery machine, and may be part of a machine control protocol using packet-based communications, such as Transfer Control Protocol (TCP), or other suitable data communication protocol, including those conforming to the Open Systems Interconnection reference model. The identification address enables identification of one embroidery machine or more of a plurality of embroidery machines to be used in the embroidery application. Preferably, the identification address, or identification information for the embroidery machine based on an identification address received, is displayed to a remote user over one or more local nodes in a form or format, such as an graphical user interface icon, that can be selected by the remote user. Alternatively, the identification address to each among the plurality of embroidery machines may be stored and can be provided by the server 45 to the remote user. This may allow, for instance, server 45 to identify and/or send query signals to each among the plurality of embroidery machines 30 to determine availability and present use status. The system 15 may receive the identification address from other components, such as the management console (discussed in detail hereafter), or other systems.

Using the identification addresses selected by the remote user, a pre-determined and stored embroidery pattern may then be accessed, for instance, by the server 45 and communicated in a digitally encoded format to one or more of the embroidery machines 30. Embroidery machines capable of receiving and reading digitally encoded embroidery patterns are known and include machines manufactured by Tajima, among others. Protocols for the transmission of embroidery pattern information and other machine control instructions are also known, and include embroidery specific communication protocols, such as that described in U.S. Pat. No. 6,216,618 (Improved Embroidery System Utilizing Windows CE Based GUI), the specification of which application is incorporated herein by reference. Communication of the pre-determined embroidery pattern to one or more of the embroidery machines 30 is preferably accomplished by server 45, but may also be accomplished by other components that may be networked, such as within system 15, or other extrinsic devices or components communicating with system 15.

Once the embroidery pattern is communicated to one or more of the embroidery machines 30, that machine may then be operated to apply the pattern to a work piece provided, for instance, fabric affixed within the embroidery machine hoop. The operation of the embroidery machine 30 is by ordinary automatic or manual methods known to the art input to or received by system 15.

In an alternative embodiment, operation of the embroidery machine 30 is in response to an input from the remote user, the input communicated through the communication connection between local node 10 and server 45. The initiation input at local node 10, and communicated to the server 45, prompts the server 45 to initiate operation of one or more embroidery machines 30 through the use of machine control software (which prompt may be to immediately initiate operation or to schedule operation for a later time and/or date, or to cue operation for when the embroidery machine becomes first available). Alternatively, the embroidery machine 30 operation may be initiated automatically by the system 15 or by ordinary automatic or manual methods known to the art input to or received by system 15.

In accordance with the preferred embodiment, the operating status of the one or more embroidery machines 30 is monitored and the status reported to the remote user over the communication connection with the server, preferably, status is displayed on a graphical user interface of local node 10. The operating status includes the electronic detection and processing of various metrics and information concerning the embroidery machine operation then in process, and may be displayed to the remote user in both detailed or summary form. The display may include such information as the time spent in the operation, the estimated time remaining in the operation, errors or malfunctions, and other information from which a user can determine whether further intervention is required and when the embroidery machine will satisfactorily and/or efficiently complete the operation.

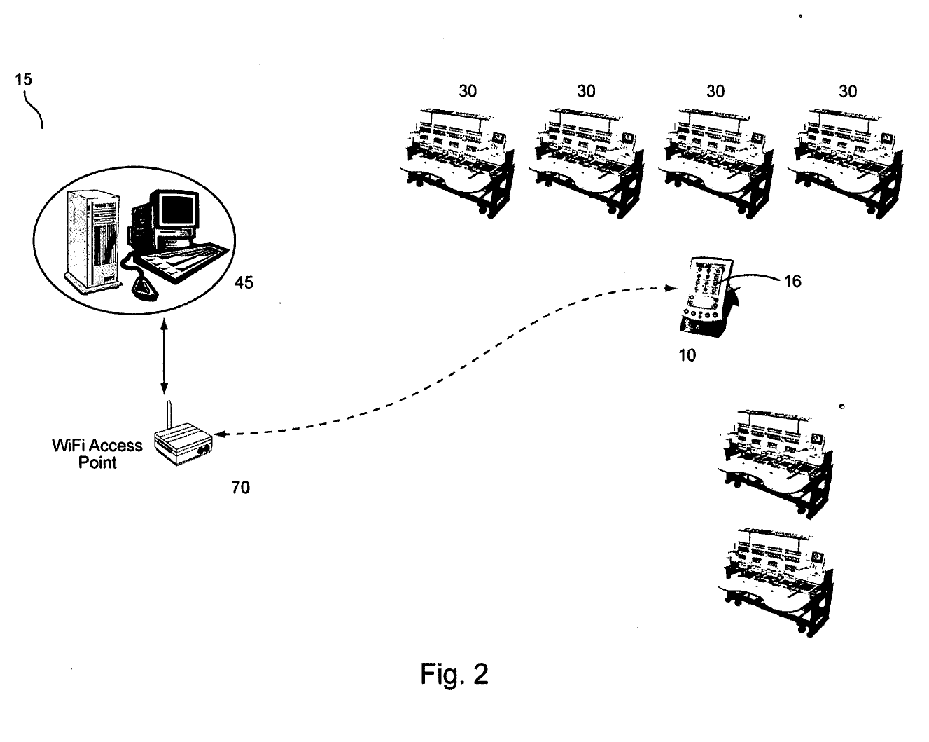

FIG. 2 illustrates the human interface portion of the preferred embodiment illustrating the server 45, access point 70 and local node 10. The server 45 is a central processing unit, which may be a PC, Macintosh, mainframe, a server-based host system, an internet information server, or other hardware platform. The server 45 may utilize operating system such as Windows 2000, Windows XP, Linux or other operating software appropriate to the operating conditions presented, such as the size and extent of the network. The server 45 incorporates software for the operation and networking of embroidery machines 30, for instance, this may be a software suite available commercially from Pulse Microsystems under the trademark PASSPORT. The server 45 may also optionally interface with the software for the operation and networking of the embroidery machines 30 through an embroidery design engine, the engine providing for embroidery functionalities such as creation of embroidery lettering, creation of an embroidery design or pattern that merges an existing design with embroidery lettering, conversion of an image into an actual embroidery design or pattern, or other functionalities known to the trade.

The server 45 also includes circuitry for receiving and transmitting wireless electronic communications, preferably within a wireless local area network (LAN). In the preferred embodiment, the server 45 circuitry includes a gateway or access point 70 for wireless LAN communications with the local node 10. This is preferably a wireless LAN communication system based on the guidelines set forth in IEEE 802.11 (also known also as a WiFi network, WiFi being a trademark registered to the WiFi Alliance) transmitting and receiving signals on a specific radio band frequency. Alternatively, the server 45 may communicate directly (“peer-to-peer”) with devices rather than through a gateway or access point. The server 45 may also include or communicate with a wireless LAN transceiver or “base station” that connects to a wired LAN.

Using a Transfer Control Protocol (TCP) communications system, the server 45 may receive wireless electronic communications from various remote devices, including mobile units, in the form of packets, reading the addresses included in the packets and routing them to the appropriate computer station, working with any other network devices, such as routers, to choose the best path to send the packets on. The access point 70 is a standard “WiFi” access point that supports about 15 to 20 users and the wireless LAN typically extends between about 100 to 300 feet indoors and about 2000 feet outdoors. Providing multiple access points with or communicating with the server 45 is within the scope and contemplation of the invention, which access points, if separated, may be integrated and communicate with each other wirelessly or may be connected via Ethernet cables to create a single network. As the design and implementation of the wireless system is subject to variations in design, an applicable network is not limited to the distances provided above.

The access point 70 may be a transmitter/receiver wirelessly communicating with radios embedded or attached to remote mobile devices in the network. The server 45 thus sends and receives signals from the radios to communicate with the various remote users through local nodes 10, which preferably are mobile units, and may also connect the mobile units to each other as well as to the Internet. Mobile units thus connected may share resources, exchange files and use a single Internet connection.

Using a wireless communications network, preferably a wireless local area network (LAN), a wireless electronic communications connection is established between the server 45 and a local node 10 operated by a remote user. The local node 10 may be a personal data assistant (PDA) providing an easily portable mobile unit. A wireless connection may also be accomplished by the mobile unit, using, for instance, a web browser or custom software application, through a separate wireless connection, and linked to the server 45 through TCP/IP ports over the “World Wide Web” (hereafter “web”) or other global computer network.

Alternatively, local node 10 may communicate with the server 45 through a wired electronic communications system, such as through a wired LAN, for instance, using Ethernet cable connectivity, or through a physical connection to a Linux box or over another wired communications system. Whether wired or wireless, the local node 10 maintains a connection with the server 45 enabling a remote user to send instructions to the server 45 to retrieve electronically encoded data corresponding to an embroidery pattern in response to a pattern selection input communicated by the remote user to the server 45 over an electronic communication link from the local node 10. Through an input made at the local node 10 the remote user also provides the server with the identification address of one or more embroidery machine selected from a plurality of embroidery machines. By this identification address, the server 45 electronically communicates with the selected embroidery machines to communicate the data, which encodes the embroidery pattern. The system also provides for the server 45 to be in communication with the plurality of embroidery machines, and the local node 10 displays to the user, through the graphical user interface, field prompts or selection lists that enable the same embroidery pattern to be communicated to a plurality of embroidery machines the remote user may select, with the identification addresses of these selected machines being communicated through the local node 10 to the server 45. Consequently, the same functionality may enable selection inputs designating multiple patterns, each embroidery pattern being communicated to an embroidery machine selected on the local node 10, the identification address for each machine then being communicated by the local node to the server 45 over the communications link.

In the preferred embodiment, two or more of the plurality of embroidery machines 30 operate in a network configuration. According to the input of a remote user at the local node 10 as described above, a first embroidery machine is selected and its identification addresses is communicated to the server over the electronic communication link, the remote user selects an embroidery pattern for the server to retrieve and communicate to the first embroidery machine; the remote user then may select a second embroidery machine by communicating its identification address to the server and then select an embroidery pattern for the server to retrieve and communicate to the second embroidery machine The operation of the first and the second embroidery machines are initiated in response to an input by the remote user, and the embroidery machines apply the respective embroidery patterns to work pieces. In this fashion, a single machine operator using a single local node may operate a plurality of embroidery machines on the network.

In accordance with the components of FIG. 2, the human interface layer of the instant invention comprises the wireless communication exercised by a remote user to the server 45 in order to send and receive data implementing and monitoring embroidery operations by embroidery machines. Local node 10, preferably a PDA or other mobile unit, establishes and maintains a wireless communications connection with the server 45, using access point 70, if a wireless LAN is used, for the transmission and receipt of data in response to the remote user's input onto a graphical user interface 16 of the local node 10. As the wireless communication system requires only a standard transmitter, such as a radio or satellite connection, the local node 10 need not be specialized, customized or otherwise loaded with specialized software to function with system 15. Whether in a wired or wireless connection, the local node 10 need not be specialized, customized or otherwise loaded with specialized software to function with system 15. For instance, local node 10 may communicate with the server through a web browser program, or other standard communications functionality, whereby inputs to a graphical user interface 16 on the local node 10 are transmitted to the server 45, are read, translated and their corresponding instructions implemented by server 45 in its interactions with the system 15 and its components.

In summary form, the functionalities within the graphical user interface 16 receive and output information to the user, and communicate with the server 45 and, optionally, with other portions of system 15. As shown and preferred in FIG. 2, the system architecture includes a group of conventional system components arranged in a unique manner through the use of the graphical user interface 16. In one embodiment, the graphical user interface on the local node 10 may have a Windows based interface that may include selectable options specific to embroidery design. Standard and commercially available web browser software may be used to transfer, translate and display data over the wireless communications link with the server 45.

The server 45 communicates with a database (not pictured), which may be part of the server 45, or extrinsic to it and accessible by the server 45 over an electronic communications connection. The database stores electronically encoded data corresponding to embroidery patterns, among other stored data and functionalities system 15 may use. Preferably, local node 10 displays to the remote user field prompts and/or selection lists through the graphical user interface 16 by which the user may input selections of embroidery patterns. In response to this input, the server 45 retrieves the electronically encoded data corresponding to the embroidery pattern selected. The server 45 incorporates a program or module that recognizes and/or translates the input from the remote user received from the local node 10 by the server 45 and, in response, retrieves the selected embroidery pattern.

Through wireless communication with the server 45, the remote user on the local node 10 may also access data from the database through the graphical user interface 16, to perform remote operations such as to open and browse the embroidery design patterns stored in the database. Based on data retrievable through the server 45 from the database, the remote user may select various metrics relating to the embroidery operation such as source embroidery design data, select embroidery patterns and lettering elements, including the element's text, font, position and envelope, or select portions of each embroidery pattern to merge, including stitch data, position and stop information, as well as editing information such as resizing or rotating, or conversion commands for stitch file format conversion or auto-digitization. Thus, by linking the database, the server 45 can provide, through the wireless communication link, to the remote user the full functionality available within the Pulse Stitchport line of products available from Pulse Microsystems (described also in U.S. Pat. No. 6,196,146) and stored within the database including, but not limited to, stitch file generation and manipulation, auto-digitization, lettering, 3D rendering, file conversion, and the generation and manipulation of outline files. Interface between the server 45 and the database may be through an embroidery design engine as previously described.

The local node 10 displays on the graphical user interface 16 field prompts and/or selection lists to provide an identification address for providing a machine selection input specifying the embroidery machine 30 to be used in applying the pattern selected to a work piece. This identification address is input by the remote user into the local node 10 and is received by the server 45. Alternatively, the identification address may be received from a machine selection input communicated from another component in the system 15, for instance, the management console 55. The display of the local node 10 also enables the remote user to input a plurality of identification addresses, and so select a plurality of embroidery machines to operate with one or more patterns the remote user has selected. Allocation of the embroidery pattern(s) selected to each identification address may be made through the local node 10 graphical user interface 16. Therefore, a remote user can select one embroidery pattern to be communicated to more than one embroidery machine 30, or alternatively, can select more than one embroidery pattern, and direct that each one selected be communicated to a particular embroidery machine 30. The graphical user interface 16 also provides for display of icons, or other input means known in the art.

In an example of remote user operation according to the preferred embodiment, using a personal data assistant (PDA) the remote user manipulates the display of the PDA graphical user interface, through a stylus or other pointer mechanism, to inserting information in the required field, by selecting options from a pull down list, by using a bar code reader intrinsic to or linked with the PDA, such as an infrared scanner, to read barcodes coding information such as the identification or address of various embroidery machines, or by using another method of selection supported by the operating software supporting the graphical user interface, for instance a windows based operating system. In so doing, the remote user: 1) selects an address of a first embroidery machine, 2) selects an embroidery pattern, 3) allocates the pattern to the first machine (for instance, by entering the design into a field prompt space for the first embroidery machine or by dragging and pulling the design to, for instance, an icon representing the first embroidery machine), 4) selects an address of a second embroidery machine, 5) select an embroidery pattern (which may be the same as or different from the pattern allocated to the first embroidery machine, and 6) and allocates the pattern to the second embroidery machine.

Communication to a server of the selection input of embroidery machines may be done sequentially or may be accomplished through a batch process sending the selected designs to the respective machines nearly simultaneously. Thus, with a single step, e.g., clicking on a “submit” or “enter” icon on the PDA graphical user interface, an initiation input by the remote user communicates the server 45, and hence, system 15 to initiate operation of the selected embroidery machines 30 to apply the selected embroidery pattern or patterns. A further section of the graphical user interface 16 (for instance, a separate windows screen or window) displays information received from the server 45 as to the operating status of the embroidery machines to the remote user.

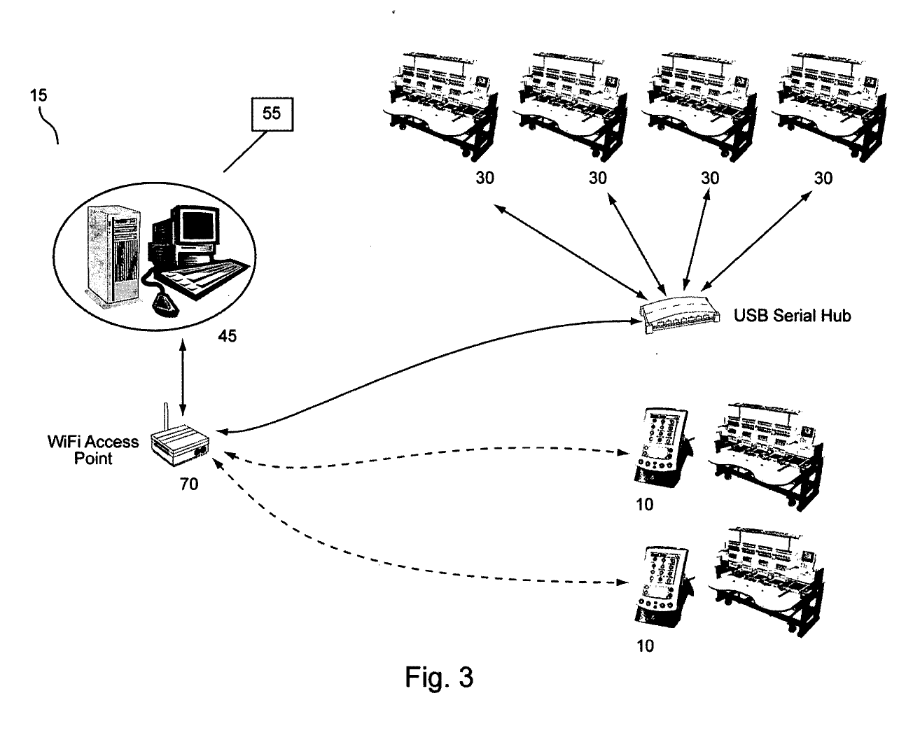

FIG. 3 illustrates in block diagram form the components of the machine interface level of the preferred embodiment. The server 45 is in communication with a plurality of embroidery machines 30 and, through the specialized software loaded thereon, can operate the embroidery machines 30 and monitor their status in response to instructions provided by the remote user through the local node 10. Two or more of the embroidery machines 30 are connected through a network configuration that enables the server 45 to send embroidery pattern data to one or more of a plurality of embroidery machines. The operation of the embroidery machines may be directed by the remote user by selecting the desired embroidery machines 30 through the graphical user interface of local node 10, which input is then communicated to the server 45 through the wireless communication connection or a wired communication connection (as described previously). Standard connections (using either a serial or parallel communications protocol) from the server 45 may be used to connect with the embroidery machines, passing them the operations data. A filtering device may be used in this connection to protect the server 45 and the machines 30. Separate computer nodes (not pictured) intermediate between the server 45 and a set of two or more embroidery machines 30 may also be interposed to effect the connection. Other methods of connection will occur to those skilled in the art.

Alternatively, the server 45 may be connected with the embroidery machines through other connection configurations. The available options include using a hub configuration, for instance, a Universal Serial Bus (USB) hub, that is branched to multiple embroidery machines. Hub configurations, including USB to serial hubs or other intermediaries with multiple ports may also be used. Another connectivity option is to use a LAN connecting server 45 to a plurality of embroidery machines 30 for instance using a bus topology, daisy chain or ring configuration, using devices for converting the TCP signals to serial at each embroidery machine. This LAN can be either a physical LAN, using, for instance, an Ethernet cable, or a second wireless LAN connection.

Server 45 may utilize conventional server based software applications to access and send encoded data comprising embroidery pattern designs for download by embroidery machines. Other conventional applications allowing server 45 to monitor the operations of embroidery machines 30, for instance, by sending query signals and receiving data reporting operation status from the embroidery machines 30 are also known and available. For instance, server 45 may implement a suite of server applications, embodied for instance, by a fully integrated version of the Passport Embroidery Network Librarian Server, Passport Controller and Pulse Business Manager applications available from Pulse Microsystems. In such embodiment, the applications implemented by and/or within server 45 may include a database of data corresponding to various pre-determined embroidery patterns as available in Passport Librarian Server and an embroidery production database, each accessed and implemented through an embroidery specific protocol such as, for instance, the Embroidery Production Network Protocol or EPN protocol, an embroidery specific conventional socket based communication protocol. The EPN protocol (described in U.S. Pat. No. 6,216,618) communicates with embroidery design databases, allowing search or browsing of designs, and accessing and extracting designs for processing, as well as storing modified or new designs. Additionally, the EPN protocol allows access to an embroidery production database; to send production status to embroidery production monitoring workstations using Passport Status, as available from Pulse Microsystems; or to save production information such as sewing progress, start and end time, and production events such as thread and needle breaks, as a Passport Smart Box or Pulse Signature Express application, as available from Pulse Microsystems.

Using such embroidery specific communication protocol, or conventional data communication protocols which allow server 45 to monitor the functionality of embroidery machine, data and/or information reporting the operational status of embroidery machines 30 are received and reported by the server 45 to the local node 10 for display as information and/or metrics in a suitable manner for viewing on the graphical user interface 16.

The presently preferred embroidery machine incorporates conventional embroidery machine controllers, such as available from Tajima, and include the ability to manage embroidery machine memory slots; allowing downloading of embroidery designs into the embroidery machine for processing; and to set embroidery machine parameters such as the needle bar, manual or automatic color changes and other parameters for embroidering the embroidery pattern design. The machine controller also compiles data and information regarding the status of the machine's operation and also communicates with server 45, which may then send the information or data received to be displayed graphically on the local node graphical user interface 16.

The embroidery machines and/or machine controllers include means for enabling communications with other devices, for instance, server 45, via handshake packet based commands, acknowledgment replies, and status messages. In an alternative embodiment, a machine control protocol may be employed to establish a Master-Slave relationship between the server 45 and the embroidery machines, by which the server 45 sends commands conventionally translated by the machine controller into embroidery machine operations. Thus, communication with, for instance, the machine controller may allow the remote user to essentially initiate machine controller operations. The controller operations performed comport with those performed by incorporates conventional embroidery machine controllers, such as available from Tajima, and include the ability to manage embroidery machine memory slots; allowing downloading of embroidery designs into the embroidery machine for processing; and to set embroidery machine parameters such as the needle bar, manual or automatic color changes and other parameters for embroidering the embroidery pattern design and to control the starting, stopping and speed of the sewing process; to inform the embroidery machine operator of errors; to step sequentially through the embroidery design, forwards or backwards by stitches or stops; to control the movement of the embroidery machine frame, to move left, right, forwards or backwards, trace designs, or return to origin. The machine controller also compiles data and information regarding the status of the machine's operation and also communicates with server 45, which may then send the information or data received to be displayed graphically on the local node graphical user interface 16.

In an alternative embodiment, a management console 55 is provided to monitor, modify and control operations of the server 45, the database and the embroidery machines 30. The console is a node, which may be a PC, laptop, PDA, Macintosh or other processing unit communicating with the server and the database, configured to run a software program, or suite of programs, to receive and display the input from local users for embroidery machine operations, modify the input, if desired, and to “push” patterns out to the embroidery machines. In one embodiment, the management console 55 is a standard embroidery process workstation, that may now be essentially by-passed by the wireless local node LAN connection disclosed by the invention, yet remains useful to make changes and to manage and monitor embroidery operations on-site. Per the present invention, the management console 55 would gain the additional feature of having a communication connection to the server in order to receive and process the instructions received from a remote user. Through the provision of an e-mail or other messaging link, the management console may also communicate with remote users on local nodes and may receive messages, data and information from the remote users through the server. The management console can thus be linked to the server by communications methods and systems known to the trade, including LANs, both wired and wireless, and other connectivity systems.

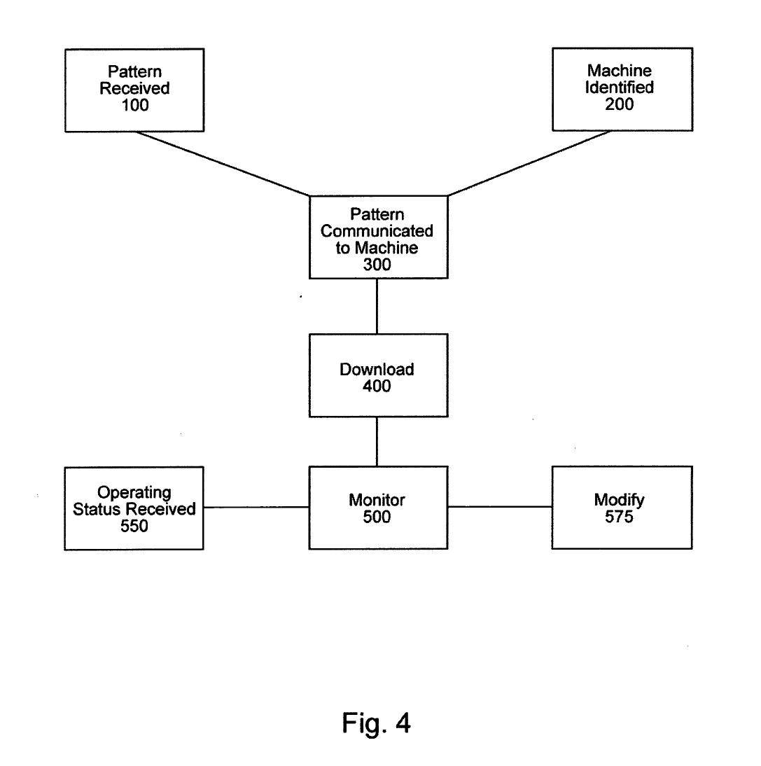

FIG. 4 provides a process flow diagram illustrating the method of the preferred embodiment of the invention. The preferred method is performed in accordance with the components illustrated in FIG. 1. In this method the server 45 is the central processing connection in wireless communication with at least one, and preferably a plurality of remote users on local nodes, which may be mobile units such as PDAs, maintaining a wireless communications link with the server 45. At functional block 100 the server receives data corresponding to at least pre-determined one embroidery pattern, which may be the location in a database or other system containing stored data, or a pathway thereto, the data communicated over a wireless electronic communication link from a local node operated by a remote user. At functional block 200 the server receives data identifying an embroidery machine remote from the user and the server, the server in communication with the identified embroidery machine. At functional block 300, the server communicates the embroidery pattern data to the identified embroidery machine. At functional block 400, the embroidery machine receives and downloads the embroidery pattern data used to stitch an embroidery pattern onto a work piece.

The method further includes certain alternative and/or additional steps peripheral to the operation of the embroidery machine. At functional block 500, the server monitors an operating status of the embroidery machine and receives the operating status of the embroidery machine, reporting the status to the remote user over the wireless electronic communication link. At associated functional block 550, alternatively or additionally, the operating status of the embroidery machine is received at a management console and displayed on a graphical user interface on the management console. Associated functional block 575 provides for the management console modifying the embroidering instructions.

Alternatively, the server may receive data identifying a plurality of embroidery machines from one or more remote users. In response, the server communicates the requested pattern to a first identified embroidery machine and communicates the same or a different embroidery pattern to a second identified embroidery machine. Operation of the embroidery machines is then initiated, preferably in a parallel operation. This alternative may also involve monitoring an operating status of one of the first embroidery machine and the second embroidery machine and receiving at the server the operating status and reporting the operating status to the remote user over the wireless electronic communication link.

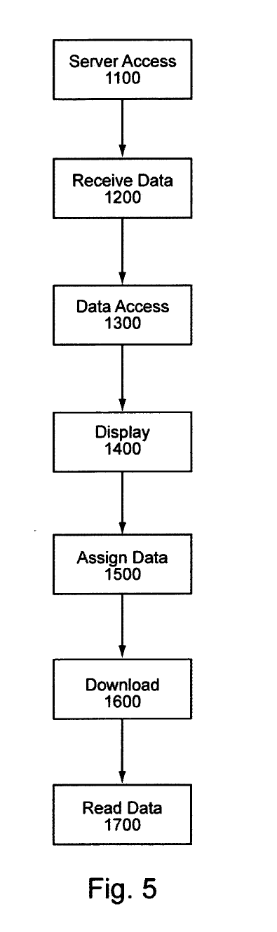

FIG. 5 provides a process flow diagram illustrating operation of a method according to an embodiment of the invention as performed based on the elements and structures of FIGS. 2 and 3 and their descriptions. At functional block 1100, a local user accesses the server from a local node through a wireless connection. At functional block 1200, the local node receives data from the server through the wireless connection, the data corresponding to a pre-determined embroidery pattern accessible by the server. At functional block 1300, in response to an input received from the local node, the server accesses a set of encoded data comprising embroidery instructions for an embroidery machine, the data corresponding to the pre-determined embroidery pattern, and displaying the data on a graphical user interface at the local node. At functional block 1400, in response to an input received from a remote user, the local node displays data corresponding to a pre-determined embroidery machine on the graphical user interface of the local node. At functional block 1500, the local user, using the local node, assigns (or directs the server to assign) the encoded data to the pre-determined embroidery machine, the predetermined embroidery machine having a data storage location. At functional block 1600, the encoded data is downloaded to the predetermined embroidery machine data storage location. At functional block 1700, the encoded data is read, for instance, to derive embroidery instructions, at the embroidery machine for use to apply an embroidery pattern to a workpiece.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

1) A method of remotely providing predetermined embroidery patterns to embroidery machines for application of the embroidery pattern to a fabric workpiece, the method comprising:
(a) providing an embroidery pattern in response to a pattern selection input from a remote user at a local node, the input communicated to a server through a communications connection between the local node and the server;
(b) selecting an embroidery machine from a plurality of embroidery machines provided;
(c) communicating the embroidery pattern to the embroidery machine.

2) The method of claim 1, wherein the communications connection between the local nodes and the server is a wireless communications connection.

3) The method of claim 1, further comprising:
(a) monitoring an operating status of the embroidery machine; and
(b) reporting the operating status to the remote user over the wireless communication connection.

4) The method of claim 2, wherein the wireless communication connection between the local node and the server comprises a wireless local area network.

5) The method of claim 1, wherein the local node is a personal data assistant.

6) The method of claim 1, further comprising displaying a graphical representation of the embroidery pattern to the remote user through a graphical user interface on the local node.

7) The method of claim 3, further comprising receiving the operating status of the embroidery machine at a management console having a graphical user interface and displaying the operating status of the embroidery machine on the graphical user interface.

8) The method of claim 7, further comprising:
(a) displaying specifications concerning one of the embroidery patterns, the operating status and the identification address on the management console graphical user interface; and
(b) modifying the specifications from the management console.

9) The method of claim 1, wherein the embroidery pattern is a user customized embroidery pattern.

10) The method of claim 1, wherein the pattern is communicated to the embroidery machine over a local area network.

11) The method of claim 10, wherein the pattern is communicated to the embroidery machine through a transmission control protocol to serial converter, the converter in communication with the local area network.

12) The method of claim 10, wherein the local area network is a wireless local area network.

13) The method of claim 1, wherein the plurality of embroidery machines are in a network configuration selectively operable from the local node.

14) The method of claim 1, the pattern is communicated to the embroidery machine through a universal serial bus hub.

15) A method of operating a plurality of embroidery machines comprising:
(a) receiving at a server electronically encoded data corresponding to an embroidery pattern in response to a pattern selection input communicated to the server over a wireless electronic communication link from a local node operated by a remote user;
(b) receiving at the server the identification address of an embroidery machine selected from a plurality of embroidery machines in response to a machine selection input communicated to the server over the wireless electronic communication link, the server in electronic communication with the plurality of embroidery machines;
(c) communicating the data to the embroidery machine for application of the embroidery pattern onto a work piece.

16) The method of claim 15, wherein the local node is a personal data assistant.

17) The method of claim 15, further comprising displaying a graphical representation of the embroidery pattern to the remote user through a graphical user interface on the local node.

18) The method of claim 15, further comprising receiving an operating status of the embroidery machine at a management console and displaying the operating status on a graphical user interface on the management console.

19) The method of claim 15, further comprising:
(a) monitoring an operating status of the embroidery machine; and
(b) Reporting the operating status to the remote user over the wireless electronic communication link.

20) The method of claim 15, wherein the embroidery pattern is a user customized embroidery pattern.

21) The method of claim 15, wherein the wireless electronic communication link is a local area network.

22) The method of claim 21, wherein the server communicates with the embroidery machine over the local area network.

23) The method of claim 22, wherein the server communicates with the embroidery machine through a transfer control protocol to serial converter, the converter in communication with the local area network.

24) The method of claim 15, wherein at least two of the plurality of embroidery machines are in a parallel network configuration selectively operable by the local node.

25) The method of claim 24, wherein the embroidery machine is a first embroidery machine, the identification address is a first identification address, the machine selection input is a first machine selection input, and the work piece is a first work piece, the method further comprising:
(a) Receiving at the server a second identification address of a second embroidery machine in a communication with the first embroidery machine, the second identification address selected from the plurality of embroidery machines in response to a second machine selection input communicated to the server over the wireless electronic communication link;
(b) Communicating the embroidery pattern to the second embroidery machine at the second identification address.

26) The method of claim 24, wherein the embroidery pattern is a first embroidery pattern, the identification address is a first identification address, the selection input is a first selection input, and the work piece is a first work piece, the method further comprising:
(a) Receiving electronically encoded data corresponding to a second embroidery pattern;
(b) Receiving a second identification address of a second embroidery machine in a parallel communication configuration with the first embroidery machine;
(c) Communicating the second embroidery pattern to the second identification address.

27) A computerized system for users to remotely implement and monitor the application of embroidery patterns onto fabrics by embroidery machines, the system comprising:
(a) a server having circuitry for receiving wireless electronic communications;
(b) a local node having a graphical user interface for receiving input from a remote user, the local node in wireless electronic communication with the server;
(c) a database of electronically encoded data, the data comprising embroidery patterns, the database in communication with the server, and responsive to the local node input, to retrieve embroidery patterns and to display the embroidery patterns through the server to the remote user; and
(d) An embroidery machine in communication with the server, the embroidery machine receiving embroidery patterns from the database through the server.

28) The system of claim 27, wherein the embroidery machine is a first embroidery machine and the system further comprises a second embroidery machine configured to operate in a parallel network configuration with the first embroidery machine, the first and second embroidery machines selectively identified for operation and communication by the local node.

29) The system of claim 27, wherein the local node is a personal data assistant.

30) The system of claim 27, further comprising monitoring and reporting means in communication with the server and the embroidery machine, the means for monitoring and reporting the operational status of the embroidery machine during application of the embroidery pattern.

31) The system of claim 30, wherein the monitoring and reporting means communicates with server to display the operating status of the embroidery machine on the graphical user interface of the local node.

32) The system of claim 27, wherein the server communicates with the embroidery machine through a universal serial bus hub.

33) The system of claim 27, wherein the wireless electronic communication circuitry supports a wireless local area network.

34) The system of claim 27, wherein the server communicates with the embroidery machine through a transmission control protocol to serial converter.

35) The system of claim 28, further comprising a management console in communication with the first and the second embroidery machines, the console for monitoring the operating status of the first and the second embroidery machines.

36) The system of claim 35, wherein the management console is in communication with the local node through the server.

37) The system of claim 36, wherein the management console is in communication with the database to select embroidery patterns for communication by the server to one of the first and the second embroidery machines.

38) A method of downloading data by remotely accessing a server from a local node in wireless communication with the server, the data comprising a pre-determined encoded embroidery pattern, to an embroidery machine for use, in embroidering the predetermined embroidery pattern onto a fabric workpiece affixed to the embroidery machine, the method comprising:
a) accessing the server from a local node through a wireless connection;
b) receiving data from the server through the wireless connection, the data corresponding to a pre-determined embroidery pattern accessible by the server and displaying the data on a graphical user interface at the local node;
c) in response to an input received from the local node, accessing a set of encoded data comprising embroidery instructions for an embroidery machine, the data corresponding to the pre-determined embroidery pattern;
d) in response to an input received from a user, displaying data corresponding to a pre-determined embroidery machine on the graphical user interface of the local node;
e) assigning the encoded data to the pre-determined embroidery machine, the pre-determined embroidery machine having a data storage location;
f) downloading the encoded data to the predetermined embroidery machine data storage location; and
g) reading the encoded data embroidery instructions at the embroidery machine to apply an embroidery pattern to a workpiece.

39) The method of claim 38, further comprising:
(a) receiving an operating status of the embroidery machine at the server; and
(b) sending the operating status to local node over the wireless communication connection for display to a remote user.

40) The method of claim 38, wherein the wireless communication connection between the local node and the server comprises a wireless local area network.

41) The method of claim 38, wherein the local node is a personal data assistant.

42) The method of claim 38, further comprising displaying a graphical representation of the embroidery pattern to the remote user on the graphical user interface of the local node.

43) The method of claim 39, further comprising receiving the operating status of the embroidery machine at a management console having a graphical user interface and displaying the operating status of the embroidery machine on the graphical user interface.

44) The method of claim 43, further comprising:
(a) displaying specifications concerning one of the embroidery pattern, the operating status and the identification address on the management console graphical user interface; and
(b) modifying the specifications from the management console.

45) The method of claim 38, wherein the embroidery pattern is a user customized embroidery pattern.

46) The method of claim 38, wherein the pattern is communicated to the embroidery machine over a local area network.

47) The method of claim 46, wherein the pattern is communicated to the embroidery machine through a transmission control protocol to serial converter, the converter in communication with the local area network.

48) The method of claim 46, wherein the local area network is a wireless local area network.

49) The method of claim 38, wherein the embroidery machine is one of a plurality of embroidery machines linked in a network configuration, the network accessible from the local node.

50) The method of claim 38, the pattern is communicated to the embroidery machine through a universal serial bus hub.
